(19) United States
(12) Patent Application Publication
(10) Pub. No.: US 2024/0396223 A1
(43) Pub. Date: Nov. 28, 2024

(54) LENS FOR A RADIO FREQUENCY ANTENNA AND APPARATUS CONTAINING THE SAME

(71) Applicant: ROGERS CORPORATION, Chandler, AZ (US)

(72) Inventors: William BLASIUS, Charlton, MA (US); Brian LEDUKE, Brookfield, MA (US); Christopher J. CAISSE, North Kingston, RI (US); Sergio CLAVIJO, Chandler, AZ (US); Pramod Srinivas BHAT, Chandler, AZ (US); Aaron GRACE, Chandler, AZ (US)

(21) Appl. No.: 18/672,474

(22) Filed: May 23, 2024

Related U.S. Application Data
(60) Provisional application No. 63/469,212, filed on May 26, 2023.

(51) Int. Cl. H01Q 15/08; H01Q 19/06

(52) U.S. Cl. CPC H01Q 15/08; H01Q 19/06

(57) ABSTRACT

An combination of an open trough waveguide antenna (TWGA) and lens fixedly attached to the TWGA. The combination of the TWGA and lens provides an antenna assembly that is suitable for use in a radio frequency antenna applications. The lens has a dielectric medium, and a plurality of non-conductive filler particles dispersed in the dielectric medium. The lens has a relative dielectric constant (Dk) of equal to or less than 2; the lens has a thickness, T, of equal to or greater than 5 microns, and equal to or less than 500 microns.

### CROSS REFERENCE TO RELATED APPLICATIONS

This application claims the benefit of U.S. Provisional Application Ser. No. 63/469,212, filed May 26, 2023, which is incorporated herein by reference in their entireties.

### BACKGROUND

The present disclosure relates generally to a lens for a radio frequency antenna, and particularly to an apparatus having a combination open trough waveguide antenna and lens for a radio frequency antenna.

Existing lens art for a radio frequency antenna are known to use foamed polymers for dielectric constants below 2, and highly foamed polymers for dielectric constants below 1.5. However, these types of materials are produced in thick sheets that require excessive cutting to get to thicknesses below 500 microns, which is not cost effective. Low-cost foams such as polyurethane, silicone and natural rubber have high dielectric loss tangents and low efficiency. High-cost foams produced from polyimides absorb moisture, which means that their dielectric constant changes with the humidity in the environment. Solid polymer lenses would have too high a dielectric constant to function in a manner as disclosed herein.

The following publications may be considered as useful background art: U.S. Pat. Nos. 7,793,405; 6,433,936; US 2012/0050673; US 2021/0028538; US 2010/0238085; U.S. Pat. No. 7,847,658.

While existing lens art may be suitable for their intended purpose, the art relating to a lens for a radio frequency antenna would be advanced with a thin, low dielectric constant lens that provides both high gain and wide field of view in a low-cost construct when combined with an open trough waveguide antenna.

### BRIEF SUMMARY

An embodiment provides an antenna assembly including a lens for a radio frequency antenna, or a combination open trough waveguide antenna and lens for a radio frequency antenna, as defined by the appended independent claims. Further advantageous modifications of the lens or combination open trough waveguide antenna and lens are defined by the appended dependent claims.

In an embodiment, a lens suitable for use in a radio frequency, RF, antenna, includes: a dielectric medium, and a plurality of non-conductive filler particles dispersed in the dielectric medium. Wherein the lens has a relative dielectric constant, Dk, of equal to or less than 2; and the lens has a thickness T of equal to or greater than 5 microns, and equal to or less than 500 microns.

In another embodiment, an antenna assembly including a combination open trough waveguide antenna and lens, suitable for use in a radio frequency, RF, antenna, includes: an open trough waveguide antenna, TWGA; and, a lens comprising a dielectric medium, and a plurality of non-conductive filler particles dispersed in the dielectric medium. Wherein the lens has a relative dielectric constant, Dk, of equal to or less than 2; the lens has a thickness, T, of equal to or greater than 5 microns, and equal to or less than 500 microns; and the lens is fixedly attached to the TWGA.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1 depicts a top-down plan view of an example open trough waveguide antenna, in accordance with an embodiment;

FIG. 2A depicts a top-down plan view and a side elevation view of an example lens, in accordance with an embodiment;

FIG. 2B depicts a top-down plan view of the example lens of FIG. 2A with material structure denoted by a speckled pattern, in accordance with an embodiment;

FIG. 2C depicts a side elevation view of an example lens, in accordance with an embodiment;

FIG. 3A depicts a top-down plan view of the lens of FIG. 2A assembled to the open trough waveguide antenna of FIG. 1, in accordance with an embodiment;

FIG. 3B depicts a cross-section view through cut line 3B-3B of FIG. 3A, in accordance with an embodiment;

FIGS. 4A, 4B, 4C, 4D, 4E, and 4F, depict images that are representative of materials suitable for a purpose disclosed herein, in accordance with an embodiment;

FIG. 5 depicts azimuth gain of analytical modeling test results superimposed over empirical test results with and without a lens, in accordance with an embodiment; and

FIG. 6 depicts elevation gain of analytical modeling test results superimposed over empirical test results with and without a lens, in accordance with an embodiment;

One skilled in the art will understand that the drawings, further described herein below, are for illustration purposes only. It will be appreciated that for simplicity and clarity of illustration, elements shown in the figures have not necessarily been drawn to scale. For example, the dimensions or scale of some of the elements may be exaggerated relative to other elements for clarity. Further, where considered appropriate, reference numerals may be repeated among the figures to indicate corresponding or analogous elements, or analogous elements may not be repetitively enumerated in all figures where it will be appreciated and understood that such enumeration where absent is inherently disclosed.

### DETAILED DESCRIPTION

As used herein, the phrase “embodiment” means “embodiment disclosed and/or illustrated herein”, which may not necessarily encompass a specific embodiment of an invention in accordance with the appended claims, but nonetheless is provided herein as being useful for a complete understanding of an invention in accordance with the appended claims.

Although the following detailed description contains many specifics for the purposes of illustration, anyone of ordinary skill in the art will appreciate that many variations and alterations to the following details are within the scope of the appended claims. For example, where described features may not be mutually exclusive of and with respect to other described features, such combinations of non-mutually exclusive features are considered to be inherently disclosed herein. Additionally, common features may be commonly illustrated in the various figures but may not be specifically enumerated in all figures for simplicity, but would be recognized by one skilled in the art as being an explicitly disclosed feature even though it may not be enumerated in a particular figure. Accordingly, the following example embodiments are set forth without any loss of generality to, and without imposing limitations upon, the claimed invention disclosed herein.

An embodiment, as shown and described by the various figures and accompanying text, provides a lens suitable for use in combination with an open trough waveguide antenna, TWGA, wherein the lens is formed of a dielectric medium and a plurality of non-conductive filler particles dispersed in the dielectric medium, wherein the lens is thin, on the order of equal to or less than 500 microns, and preferably equal to or greater than 5 microns and equal to or less than 400 microns, and has a relatively low dielectric constant (Dk) on the order of equal to or less than 2, and preferably equal to or less than 1.2, and is configured to be fixedly attached to the TWGA such that the lens provides both high gain and wide field of view when attached to and electromagnetically operable with the TWGA.

An example embodiment of an integrated lens suitable for use in combination with an open trough waveguide antenna as disclosed herein uses a 450-micron thick non-woven glass fiber, wet-laid in a dielectric medium, having an average dielectric constant of 1.2. In comparison, a woven glass fabric, wet-laid in a same dielectric medium has an average dielectric constant of 2.6, or further in comparison, a solid E-Glass fiber in a same dielectric medium has an average dielectric constant of 6.7. The glass component provides rigidity while a polymeric binder holds the non-woven fibers together in a network. Another advantage of the fiberglass non-woven construct is its inherent flame resistance. Other specialty (low dielectric loss, low moisture absorption) fibers can be used to form the wet-laid non-woven lens, which include polyphenylene sulfide, polyether-imide and polyetheretherketone. In a prototype, non-limiting embodiment, a dog-bone shaped lens was cut from a sheet of non-woven glass fiber, wet-laid in a dielectric medium. The cutting can be performed with a laser (our preferred), steel rule die, scissors or scalpel. It should be appreciated, however, that any processes of obtaining the lens with a target profile/shape from the sheet can be used without departing from the scope of the inventive teachings. The lens was set into a depression molded into a trough waveguide's top metallic surface, and was bonded in place using epoxy, cyanoacrylate, ultraviolet (UV) curable acrylic adhesives, or UV curable resin. In other non-limiting embodiments, the lens can have a shape that replicates the shape of the trench without departing from the scope of the inventive teachings.

Dielectric materials for use as the dielectric medium are selected to provide the desired electrical and mechanical properties for a purpose disclosed herein. The dielectric materials include, but are not limited to, glass, polyetherimide (PEI), polyphenylene sulfide (PPS), polyether etherketone (PEEK), and liquid crystal polymer (LCP).

While embodiments illustrated and described herein depict a lens having a particular plan view profile (in the x-y plane of an orthogonal x-y-z coordinate system), it will be appreciated that such profiles may be modified without departing from a scope of the invention. As such, any profile that falls within the ambit of the disclosure herein, and is suitable for a purpose disclosed herein, is contemplated and considered to be complementary to the embodiments disclosed herein.

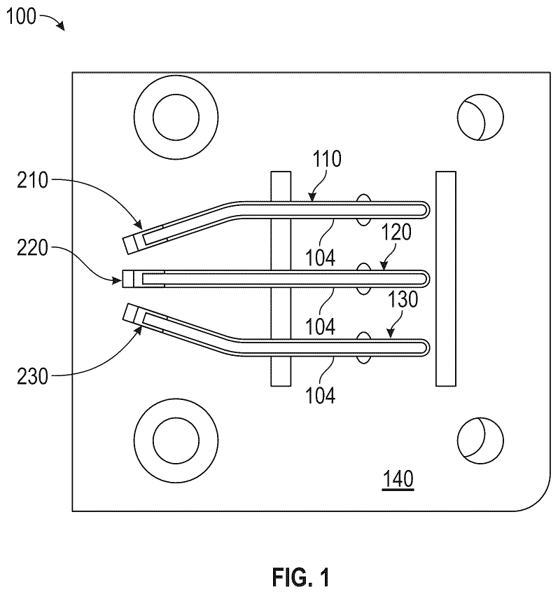

With reference now to FIG. 1, top-down plan view of an example open trough waveguide antenna, TWGA, device 100 is illustrated according to a non-limiting embodiment. The TWGA 100 includes three TWGAs 110, 120, 130 (also herein referred to as open trenches) arranged in parallel with each other in a dielectric medium 140. Signal ports 210, 220, 230 are configured at one end of each TWGA 110, 120, 130 for providing injection of an electromagnetic, EM, signal into the respective TWGA 110, 120, 130.

Example TWGAs 110, 120, 130 can be found in commonly assigned application Ser. No. 17/943,450, now U.S. Publ. No. 2023/0085413, filed 13 Sep. 2022.

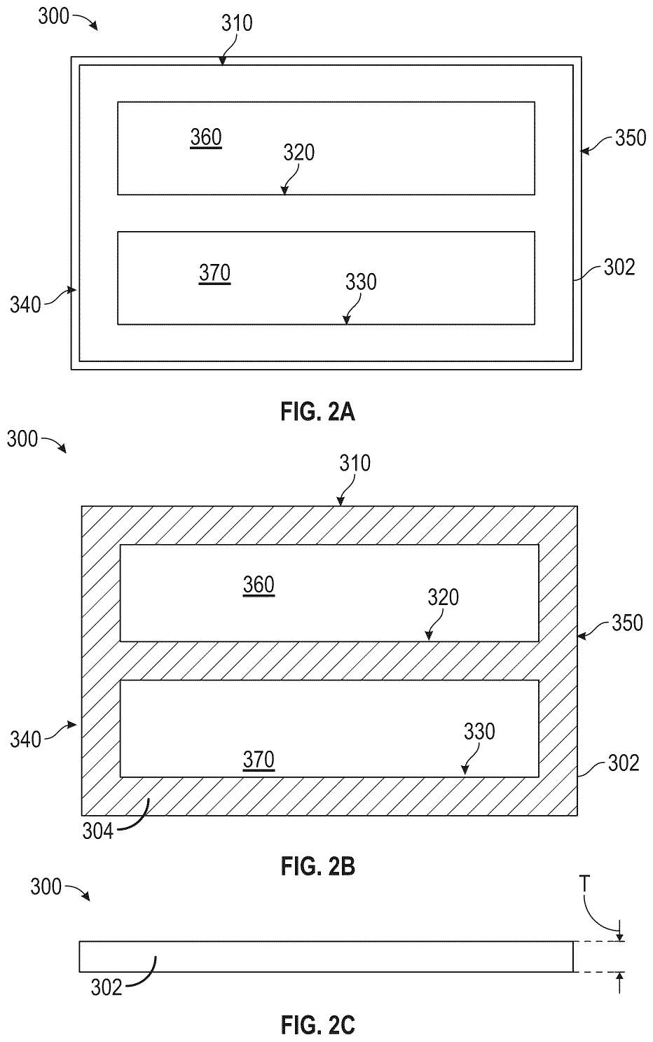

Turning now to FIGS. 2A, 2B and 2C, the lens 300 is illustrated according to a non-limiting embodiment of the present disclosure. The lens 200 includes three cover portions 310, 320, 330, and two bridging portions 340, 350 integrally formed with and bridging respective ends of the three cover portions 310, 320, 330. In an embodiment, the lens 300 has an overall thickness (T) that is equal to or greater than 5 microns and equal to or less than 500 microns, and preferably equal to or less than 400 microns. In an embodiment, the lens 300 has a Dk value of equal to or less than 2, alternatively equal to or less than 1.5, and preferably equal to or less than 1.2. In an embodiment, the lens 300 having the three cover portions 310, 320, 330 and the integrally formed two bridging portions 340, 350 form two open regions 360, 370 that is devoid of dielectric material of the lens 300.

With continued reference to FIG. 2B, the material structure 302 can be referred to as a dielectric medium 302 denoted by a speckled pattern, while the non-conductive filler particles 304 is represented by the dots of the speckled pattern. The dielectric medium 302 can comprise a polymeric binder, which holds the non-conductive filler particles 304 in a network. The binder material can include, but is not limited to, styrene-acrylics, polyimides, polyesters, styrene-acrylic polyester, epoxy, polyurethane, phenoxy, polyvinyl alcohol and water dispersible polymeric materials.

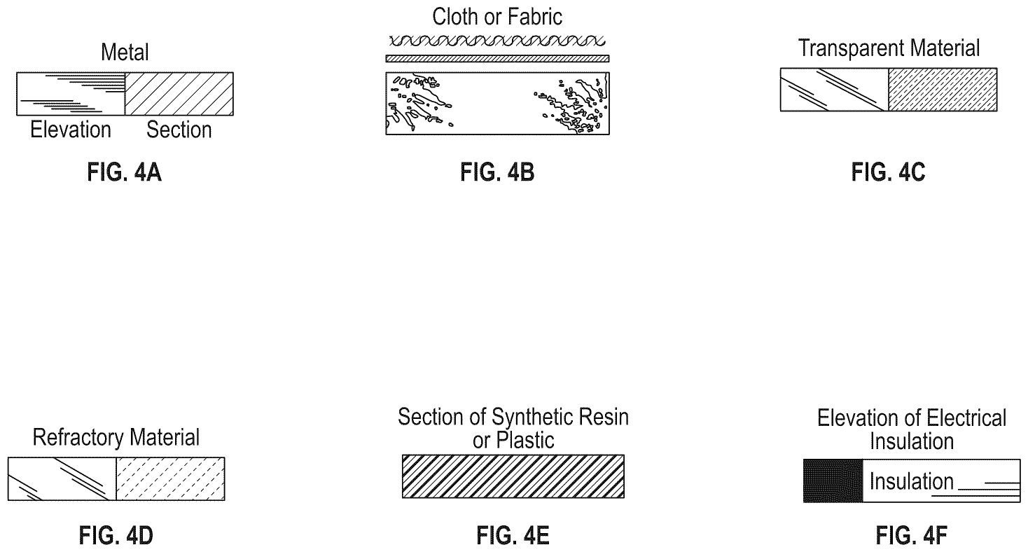

According to a non-limiting embodiment, the filler particles 304 comprise fibers. In at least one non-limiting embodiment, the fibers 304 are non-woven glass fibers. In other non-limiting embodiments, the non-woven fibers 304 comprise a polymer material including, but not limited to, polyphenylene sulfide, polyether-imide, and polyetheretherketone. In a non-limiting embodiment, the fibers 304 are disposed in a wet-laid arrangement in the dielectric medium (e.g., represented by FIG. 4B). The dielectric medium 302 can include, but is not limited to, air or gas.

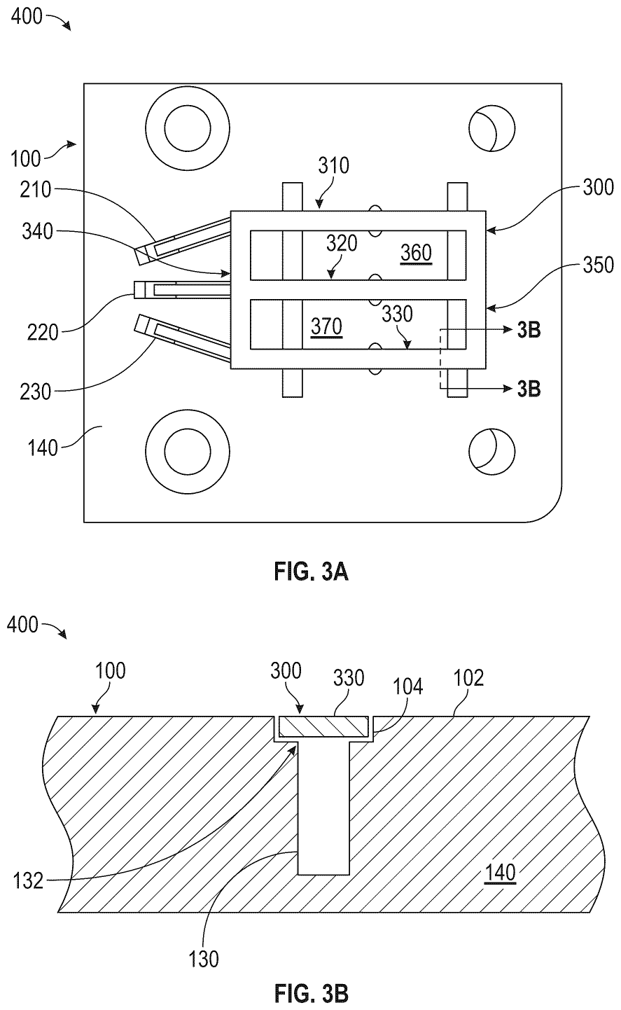

FIG. 3A depicts a top-down plan view of the lens 300 of FIGS. 2A and 2B assembled to the TWGA device 100 of FIG. 1 to provide an antenna assembly 400. FIG. 3B is a cross-sectional view of the antenna assembly 400 taken along line 3B-3B. As depicted, depressions 104 are formed in the a top surface 102 of a dielectric medium 140. According to a non-limiting embodiment, the top surface 102 comprises a metallic material to define a metal top surface. Respective ones of the cover portions 310, 320, 330 of the lens 300 are disposed in a respective depression 104 and are bonded in place. Various bonding materials can be used including, but not limited to, epoxy, cyanoacrylate, UV curable acrylic adhesive, and UV curable resin. Accordingly, the cover portions 310, 320, 330 are arranged over and in a one-to-one arrangement with corresponding ones of the TWGAs 110, 120, 130 (partially hidden from view in FIG. 3A, and best seen with reference to FIG. 1), with the two bridging portions 340, 350 extending across the three TWGAs 110, 120, 130 of the TWGA device 100. Accordingly, the cover portions 310, 320, 330 cover a top 132 of a respective open trench 110, 120, 130, while the open regions 360, 370 of the lens 300 do not overlap any portion of the TWGAs 110, 120, 13.

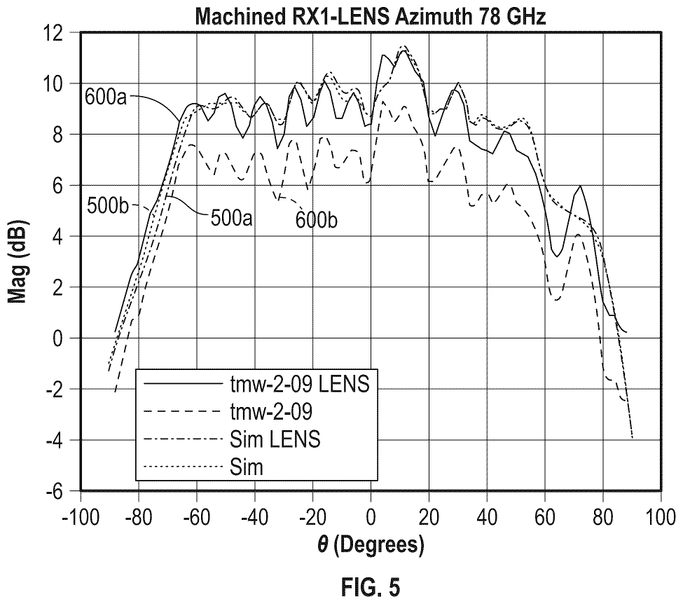

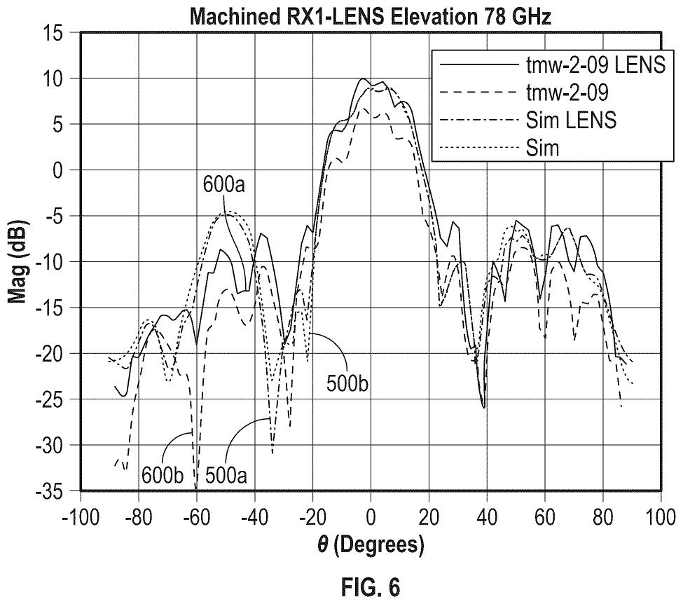

By configuring a lens 300 with structural and material properties as disclosed herein, and disposing the lens 300 over the TWGA device 100 as disclosed herein, the EM radiation from the TWGAs 110, 120, 130, when electromagnetically excited by respective ones of the signal ports 210, 220, 230, are found to have an unexpected improvement in gain with a wide field of view, which can be seen with reference to the empirical and analytical data depicted in FIGS. 5 and 6, where the lens 300 was made from a non-woven, wet-laid, material that was placed over the respective open trenches of a TWGA 100.

In the example embodiment used in FIGS. 2A, 2B, 3A and 3B, the non-woven material of the lens 300 had the following material properties: A base of ECR glass; a binder of styrene-acrylic (xSA); a weight of 30 gm/sq.m.; a thickness of 0.011-inches (279.4 microns); a Dk of 1.2601 at 10 GHz; and, a Dissipation factor, Df, of 0.00275 at 10 GHz, which is available from Optiveil®, and is known as material 20112C.

Referring now to FIGS. 5 and 6, EM radiation data of the TWGA device is graphically depicted according to a non-limiting embodiment. FIG. 5 illustrates azimuth EM radiation data, while FIG. 6 illustrates elevation EM radiation data. The dashed-line plots in each figure represent EM radiation from the TWGA device 100 absent a lens 300, and the solid-line plots in each figure represent EM radiation from the TWGA device 100 with the lens 300 attached thereto as disclosed herein. The black-colored-line plots 500a and 500b in each figure represent analytical simulation data, and the magenta-colored-line plots 600a and 600b in each figure represent empirical test data. As can be seen by the magenta-colored-line plots 600a and 600b in each figure, an improvement in gain is achieved in both the azimuth and elevation directions, with the azimuth plots showing a wide field of view from about-60 degrees to about +60 degrees. As can be further seen by comparing the magenta-colored-line plots 600a and 600b with the black-colored-line plots 500a and 500b, a close representation of the empirical data is achieved through the analytical modeling.

From the foregoing, it will be appreciated that aspects of embodiments disclosed herein include the following:

Aspect 1: A lens 300 suitable for use in a radio frequency, RF, antenna, comprising: a dielectric medium 302, and a plurality of non-conductive filler particles 304 dispersed in the dielectric medium 302 (best seen with reference to FIG. 2B); wherein the lens 300 has a relative dielectric constant, Dk, of equal to or less than 2; and, wherein the lens has a thickness T of equal to or greater than 5 microns, and equal to or less than 500 microns.

Aspect 2: An antenna assembly 400 including a combination open trough waveguide antenna 100 and lens 300 (best seen with reference to FIGS. 3A and 3B), suitable for use in a radio frequency, RF, antenna, the antenna assembly 400 comprising: an open trough waveguide antenna, TWGA, 100; and, a lens 300 comprising a dielectric medium 302, and a plurality of non-conductive filler particles 304 dispersed in the dielectric medium 302; wherein the lens 300 has a relative dielectric constant, Dk, of equal to or less than 2; wherein the lens 300 has a thickness, T, of equal to or greater than 5 microns, and equal to or less than 500 microns; and, wherein the lens 300 is fixedly attached to the TWGA 100.

Aspect 3: The antenna assembly 400 of Aspect 2, wherein: the TWGA 100 comprises at least one open trench 110, 120, 130 (see FIG. 1); and the lens 300 is disposed to cover a top 132 (collectively represented by reference numeral 132 in FIG. 3B) of the at least one open trench 110, 120, 130.

Aspect 4: The antenna assembly 400 of Aspect 3, wherein: a top surface 102 of the TWGA 100 comprises a depression 104; and the lens 300 is disposed in the depression 104.

Aspect 5: The antenna assembly 400 of Aspect 4, wherein: the top surface 102 of the TWGA 100 comprises a metallic surface (represented by FIG. 4A).

Aspect 6: The lens 300 of any one of Aspects 1 to 5, wherein: the filler particles 304 comprise fibers (represented by FIG. 4B, and also herein referred to by reference numeral 304).

Aspect 7: The lens 300 of Aspect 6, wherein: the fibers 304 comprise glass (represented by FIG. 4C), a ceramic material (represented by FIG. 4D), or a polymeric material (represented by FIG. 4E).

Aspect 8: The lens 300 of Aspect 6, wherein: the fibers 304 are non-metallic (represented by FIG. 4F).

Aspect 9: The lens 300 of Aspect 6, wherein: the fibers 304 are non-woven fibers (represented by FIG. 4B).

Aspect 10: The lens 300 of Aspect 6, wherein: the fibers 304 are non-woven fabric fibers (represented by FIG. 4B).

Aspect 11: The lens 300 of Aspect 6, wherein: the fibers 304 are loosely-woven or loosely-knit fibers (represented by FIG. 4B).

Aspect 12: The lens 300 of Aspect 6, wherein: the fibers 304 are disposed in a wet-laid arrangement in the dielectric medium (represented by FIG. 4B).

Aspect 13: The lens 300 of Aspect 6, wherein: the fibers 304 are disposed in a randomly in the dielectric medium (represented by FIG. 4B).

Aspect 14: The lens 300 of Aspect 6, wherein: the fibers 304 comprise polyphenylene sulfide, polyether-imide, or polyetheretherketone (represented by FIG. 4B).

Aspect 15: The lens 300 of any one of Aspects 1 to 14, wherein: the filler particles 304 comprise hollow spheres of ceramic or polymeric material (represented by FIGS. 2B, 4D, 4E).

Aspect 16: The lens 300 of Aspect 15, wherein: the hollow spheres are disposed in a randomly in the dielectric medium (represented by FIG. 2B).

Aspect 17: The lens 300 of any one of Aspects 1 to 16, wherein: the Dk is equal to or less than 1.5.

Aspect 18: The lens 300 of any one of Aspects 1 to 17, wherein: the Dk is equal to or less than 1.2.

Aspect 19: The lens 300 of any one of Aspects 1 to 18, wherein: the dielectric medium 302 comprises a polymeric binder.

Aspect 20: The lens 300 of any one of Aspects 1 to 19, wherein: the dielectric medium 302 further comprises air or a gas.

Aspect 21: The lens 300 of any one of Aspects 1 to 20, wherein: T is equal to or less than 400 microns.

In comparison to an embodiment as disclosed herein, air voids may be incorporated into a lens material to create a low Dk lens. The air voids may be 3D printed in a pattern using stereolithography or any other suitable method, a sheet can be perforated with multiple holes until the volume ratio of air to substrate is achieved, or a foam can be produced using a physical or chemical blowing agent. Alternative to 3D printing, a drilling process may be used for the lens, but it is a subtractive process that is slow and expensive. Further alternative to 3D printing, a foaming material may be used for the lens, which have inherent flame resistance, but absorb moisture, which changes the lens Dk depending on the environmental relative humidity. Foams are rarely made at thicknesses as low as 400 microns because most of the structure would be un-foamed skin, and thicker foams would need to be cut through the thickness to get to a suitable thickness, but 400 microns is below most commercial skiving capabilities.

As disclosed herein, the lens is quite small and would challenge the limits of physical or laser drilling to meet the low Dk requirements, and furthermore, stability and rigidity may also be compromised. Alternative to 3D printing, a wet laid non-woven process as disclosed herein can be used for the lens, which is a continuous process that yields a sheet that is stable to crushing forces, which may be encountered during the bonding procedure to the TWGA. Advantageously, fiberglass is significantly stronger and more stable than the polymers used for 3D printing. As such, it is contemplated that one or more embodiments as disclosed herein offer advantages over existing fabrication techniques.

While certain embodiments disclosed herein depict a particular open TWGA 100 having a particular open trough construct, it will be appreciated that other open trough waveguide antenna constructs will be suitable for a purpose disclosed herein, such as for example a multichannel TWGA.

While certain combinations of individual features have been described and illustrated herein, it will be appreciated that these certain combinations of features are for illustration purposes only and that any combination of any of such individual features may be employed in accordance with an embodiment, whether or not such combination is explicitly illustrated, and consistent with the disclosure herein. Any and all such combinations of features as disclosed herein are contemplated herein, are considered to be within the understanding of one skilled in the art when considering the application as a whole, and are considered to be within the scope of the invention disclosed herein, as long as they fall within the scope of the invention defined by the appended claims, in a manner that would be understood by one skilled in the art.

While an invention has been described herein with reference to example embodiments, it will be understood by those skilled in the art that various changes may be made and equivalents may be substituted for elements thereof without departing from the scope of the claims. Many modifications may be made to adapt a particular situation or material to the teachings of the invention without departing from the essential scope thereof. Therefore, it is intended that the invention not be limited to the particular embodiment or embodiments disclosed herein as the best or only mode contemplated for carrying out this invention, but that the invention will include all embodiments falling within the scope of the appended claims. In the drawings and the description, there have been disclosed example embodiments and, although specific terms and/or dimensions may have been employed, they are unless otherwise stated used in a generic, exemplary and/or descriptive sense only and not for purposes of limitation, the scope of the claims therefore not being so limited. When an element such as a layer, film, region, substrate, or other described feature is referred to as being “on” or in “engagement with” another element, it can be directly on or engaged with the other element, or intervening elements may also be present. In contrast, when an element is referred to as being “directly on” or “directly engaged with” another element, there are no intervening elements present. The use of the terms first, second, etc. do not denote any order or importance, but rather the terms first, second, etc. are used to distinguish one element from another. The use of the terms a, an, etc. do not denote a limitation of quantity, but rather denote the presence of at least one of the referenced item. The use of the terms “top”, “bottom”, “up”, “down”, “left”, “right”, “front”, “back”, etc., or any reference to orientation, do not denote a limitation of structure, as the structure may be viewed from more than one orientation, but rather denote a relative structural relationship between one or more of the associated features as disclosed herein. The term “comprising” as used herein does not exclude the possible inclusion of one or more additional features. Any background information provided herein is provided to reveal information believed by the applicant to be of possible relevance to the invention disclosed herein. No admission is necessarily intended, nor should be construed, that any of such background information constitutes prior art against an embodiment of the invention disclosed herein.

1. A lens suitable for use in a radio frequency, RF, antenna, comprising:
a dielectric medium, and a plurality of non-conductive filler particles dispersed in the dielectric medium;
wherein the lens has a relative dielectric constant, Dk, of equal to or less than 2; and
wherein the lens has a thickness, T, of equal to or greater than 5 microns, and equal to or less than 500 microns.

2. An antenna assembly suitable for use in a radio frequency, RF, antenna, the antenna assembly comprising:
an open trough waveguide antenna, TWGA; and
a lens comprising a dielectric medium, and a plurality of non-conductive filler particles dispersed in the dielectric medium;
wherein the lens has a relative dielectric constant, Dk, of equal to or less than 2;
wherein the lens has a thickness, T, of equal to or greater than 5 microns, and equal to or less than 500 microns; and
wherein the lens is fixedly attached to the TWGA.

3. The antenna assembly of claim 2, wherein:
the TWGA comprises at least one open trench; and
the lens is disposed to cover a top of the at least one open trench.

4. The antenna assembly of claim 3, wherein:
a top surface of the TWGA comprises a depression; and
the lens is disposed in the depression.

5. The antenna assembly of claim 4, wherein:
the top surface of the TWGA comprises a metallic surface.

6. The lens of claim 1 wherein:
the filler particles comprise fibers.

7. The lens of claim 6, wherein:
the fibers comprise glass, a ceramic material, or a polymeric material.

8. The lens of claim 6, wherein:
the fibers are non-metallic.

9. The lens of claim 6, wherein:
the fibers are non-woven fibers.

10. The lens of claim 6, wherein:
the fibers are non-woven fabric fibers.

11. The lens of claim 6, wherein:
the fibers are disposed in a wet-laid arrangement in the dielectric medium.

12. The lens of claim 6, wherein:
the fibers are disposed in a randomly in the dielectric medium.

13. The lens of claim 6, wherein:
the fibers comprise polyphenylene sulfide, polyether-imide, or polyetheretherketone.

14. The lens of claim 1, wherein:
the filler particles comprise hollow spheres of ceramic or polymeric material.

15. The lens of claim 14, wherein:
the hollow spheres are disposed in a randomly in the dielectric medium.

16. The lens of claim 1, wherein:
the relative dielectric constant, Dk, is equal to or less than 1.5.

17. The lens of claim 1, wherein:
the relative dielectric constant, Dk, is equal to or less than 1.2.

18. The lens of claim 1, wherein:
the dielectric medium comprises a polymeric binder.

19. The lens of claim 1, wherein:
the dielectric medium further comprises air or a gas.

20. The lens of claim 1, wherein:
The thickness, T, is equal to or less than 400 microns.
